(19) United States
(12) Patent Application Publication
(10) Pub. No.: US 2024/0417908 A1
(43) Pub. Date: Dec. 19, 2024

(54) LAUNDRY TREATING APPARATUS

(71) Applicant: LG Electronics Inc., Seoul (KR)

(72) Inventors: Dongkil CHOI, Seoul (KR); Hyeonjoong KIM, Seoul (KR); Semin JANG, Seoul (KR); Woore KIM, Seoul (KR)

(21) Appl. No.: 18/704,778

(22) PCT Filed: Oct. 26, 2022
(86) PCT No.: PCT/KR2022/016461

§ 371 Date: Apr. 25, 2024

(30) Foreign Application Priority Data
Oct. 26, 2021 (KR) 10-2021-0143966

(51) Int. Cl. D06F 37/26; D06F 25/00; D06F 33/69; D06F 39/08; D06F 39/12; D06F 58/02; D06F 58/26; D06F 105/02; D06F 105/54

(52) U.S. Cl. CPC D06F 37/266; D06F 25/00; D06F 33/69; D06F 39/083; D06F 39/088; D06F 39/12; D06F 58/02; D06F 58/26; D06F 2105/02; D06F 2105/54

(57) ABSTRACT

A laundry treating apparatus is disclosed. The laundry treating apparatus according to one embodiment of the present disclosure comprises: a cabinet including a front plate having a laundry opening; a tub which is provided in the cabinet and which includes a tub opening facing the laundry opening; a drum which is rotatably provided in the tub and which accommodates laundry; a tub gasket which is provided between the laundry opening and the tub opening, and which extends along the circumference of the laundry opening so as to seal the gap between the laundry opening and the tub opening; a gasket water supply part which is provided at the tub gasket, and into which water flows from the outside of the tub gasket during a drying operation for drying the laundry; and a water supply guider which is provided at the tub gasket, and which allows the water transferred from the gasket water supply part to flow along the inner peripheral surface of the tub gasket.

### TECHNICAL FIELD

The present disclosure relates to a laundry treating apparatus for treating laundry.

### BACKGROUND ART

A laundry treating apparatus is an apparatus for performing various treatments on laundry, such as washing or drying laundry, and includes a washing machine, a dryer, and a refresher (styler).

The laundry treating apparatus may be classified into a top-loading type laundry treating apparatus and a front-loading type laundry treating apparatus based on a method of loading laundry into a drum, and may include a cabinet defining the appearance thereof.

A washing machine capable of performing a washing process of laundry may remove contaminants from laundry, such as clothing and bedding, introduced into a drum. The washing process of laundry may include a washing cycle, a rinsing cycle, a spin-drying cycle, and a drying cycle.

A laundry treating apparatus capable of performing a washing process of laundry may include a tub provided in the cabinet and a drum rotatably mounted in the tub and configured to receive laundry, and a laundry opening, through which laundry is introduced, may be formed in the cabinet.

Laundry introduced into the cabinet through the laundry opening may pass through a tub opening formed in the tub and may be received in the drum provided in the tub, and water and detergent may be supplied into the tub to treat the laundry during the washing process of laundry.

Reference Document 1 (KR 10-2019-0101749) discloses a laundry treating apparatus having a tub gasket configured to prevent water provided into a tub provided in a cabinet from being discharged to the outside of the tub or the outside of the cabinet.

The tub gasket may be configured to seal between a laundry opening of the cabinet and a tub opening of the tub in the cabinet. When water is supplied into the tub and a washing process of laundry is performed, therefore, water may be prevented from escaping from the tub into the cabinet.

In addition, the laundry treating apparatus of Reference Document 1 may perform not only a washing cycle of laundry but also a drying cycle of laundry. In Reference Document 1, during the drying cycle of laundry, heated air may be present in the tub, and a part of the tub may be cooled, whereby moisture in the heated air may be condensed and removed. In Reference Document 1, water is supplied to an inner surface of the tub in order to cool a part of the tub, and a part of the tub is cooled during the drying cycle, whereby condensate is generated.

During a washing process of laundry, however, water containing detergent and contaminants may be present in the tub, and the detergent and the contaminants may remain on the tub gasket due to the flow of water in the tub during the washing process of laundry.

The detergent or the contaminants present on the tub gasket may remain on the tub gasket even after the washing cycle or a rinsing cycle of laundry, and may affect or adhere to the laundry in a subsequent washing process, thereby reducing hygiene and manageability.

In addition, when the drying cycle of laundry is performed to remove moisture from the laundry, the water remaining on the tub gasket may evaporate, and adhesion of the detergent and the contaminants may become severe, causing deterioration of the tub gasket and reduction of hygiene.

Furthermore, in a method of drying laundry by heating the inside of the tub while air in the tub is stagnant, as in Reference Document 1, not only water remaining on the tub gasket but also foreign matter such as dust or detergent containing moisture in the air may stick or adhere to the tub gasket, which may reduce hygiene.

Meanwhile, Reference Document 2 (KR 10-2006-0062191) discloses a laundry treating apparatus including a cleaning means provided at a tub gasket and configured to spray water toward a laundry door in order to clean the inside of the laundry door.

Since the cleaning means is provided at the tub gasket and sprays cleaning water toward the laundry door, however, water scattered after collision with the laundry door may be introduced into the drum, and therefore, when a drying cycle for drying laundry is performed, the laundry may be wet again by the cleaning means.

In addition, the cleaning means of Reference Document 2 may be disadvantageous for removing contaminants remaining on the surface of the tub gasket, and furthermore, cleaning water sprayed by the cleaning means is provided to a part of the laundry door, which may be disadvantageous for cleaning the entire surface of the tub gasket.

Therefore, it is important in the technical field of the present disclosure to effectively dehumidify air in the tub in the drying cycle of laundry and to effectively clean the tub gasket provided in the laundry treating apparatus without reducing the drying efficiency of laundry.

### Disclosure

### Technical Task

Embodiments of the present disclosure provide a laundry treating apparatus capable of effectively removing moisture from air in a tub during a drying cycle of laundry.

In addition, embodiments of the present disclosure provide a laundry treating apparatus capable of effectively cleaning and cooling a tub gasket configured to prevent water leakage during a drying cycle.

In addition, embodiments of the present disclosure provide a laundry treating apparatus capable of effectively cleaning a tub gasket while preventing water from being delivered to laundry during a drying cycle of laundry.

In addition, embodiments of the present disclosure provide a laundry treating apparatus capable of effectively increasing the cleaning area of a tub gasket and effectively cleaning main parts to be cleaned where contaminants are likely to remain.

Furthermore, embodiments of the present disclosure provide a laundry treating apparatus capable of effectively cleaning a tub gasket in a timely manner such that contaminants are not adhered to the tub gasket due to a drying cycle of laundry.

### Technical Solutions

The present disclosure relates to a laundry treating apparatus including a water supply module configured to clean a tub gasket, wherein the water supply module may be provided at the tub gasket to provide water to an inner circumferential surface of the tub gasket to clean the tub gasket.

In an embodiment of the present disclosure, the water supply module may discharge water to the inner circumferential surface of the tub gasket in a direction parallel to an inner circumferential direction of the tub gasket, thereby increasing the area over which water flows along the inner circumferential surface of the tub gasket.

In the embodiment of the present disclosure, a laundry opening may be provided in a front plate of a cabinet, and the water supply module may be located at an upper end of the tub gasket to discharge water, thereby allowing water to flow along the entire inner circumferential surface of the tub gasket.

Meanwhile, the embodiment of the present disclosure may include a heating unit configured to heat the inside of the tub, wherein the heating unit may include an induction coil configured to generate an electromagnetic field, and a drum may be heated by induced current generated by the heating unit, whereby air in the tub may be heated by the drum and a drying cycle of laundry may be performed.

In addition, the air in the tub may be heated in a stagnant state during the drying cycle of laundry, and the water supply module may effectively discharge water to the tub gasket before, during, or after the drying cycle of laundry, thereby effectively removing foreign matter that may be generated or adhered by the drying cycle from the tub gasket.

Meanwhile, the tub gasket may be provided at the inner circumferential surface thereof with a water diffusion portion configured to diffuse water provided by the water supply module, wherein the water diffusion portion may extend across the inner circumferential direction of the tub gasket, whereby water flowing through the water diffusion portion may flow beyond the water diffusion portion or flow in an extension direction of the water diffusion portion, and therefore the cleaning area may be increased.

A laundry treating apparatus according to an embodiment of the present disclosure as described above includes a cabinet, a tub, a drum, a tub gasket, a gasket water supply portion, and a water supply guide.

The cabinet includes a front plate having a laundry opening formed therein, and the tub is provided in the cabinet and includes a tub opening facing the laundry opening. The drum is rotatably provided in the tub and receives laundry.

The tub gasket is provided between the laundry opening and the tub opening, extends along the circumference of the laundry opening, and seals between the laundry opening and the tub opening, and the gasket water supply portion is provided at the tub gasket and receives water from the outside of the tub gasket during the drying cycle for drying laundry.

The water supply guide is provided at the tub gasket, and flows water delivered from the gasket water supply portion along the inner circumferential surface of the tub gasket.

The gasket water supply portion may extend through the inner circumferential surface of the tub gasket toward the outside of the tub gasket to receive water.

The tub gasket may include a protruding support portion protruding toward the outside of the tub gasket, the protruding support portion being configured to allow the gasket water supply portion to extend therethrough, the protruding support portion surrounding at least a part of the gasket water supply portion.

At least a part of the water supply guide may be located at an upper end of the inner circumferential surface of the tub gasket, and the water supply guide may include a water discharge port configured to discharge water delivered from the gasket water supply portion to the inner circumferential surface of the tub gasket.

A discharging direction of water through the water discharge port of the water supply guide may be parallel to the inner circumferential direction of the tub gasket.

The water supply guide may be connected to the gasket water supply portion to receive water, and at least a part of the water supply guide may extend on the inner circumferential surface of the tub gasket in the inner circumferential direction.

The water discharge port may be formed at each end of the water supply guide in an extension direction of the water supply guide. An outer circumferential surface of the water supply guide facing the inner circumferential surface of the tub gasket may be in contact with the inner circumferential surface of the tub gasket.

The tub gasket may include a leakage prevention protrusion protruding from an outwardly facing end of the inner circumferential surface of the tub gasket facing the outside of the cabinet toward the center of the laundry opening, the leakage prevention protrusion extending in the inner circumferential direction, the leakage prevention protrusion being in contact with the water supply guide.

The gasket water supply portion may include a water supply channel configured to allow water introduced from the outside of the tub gasket to flow therethrough, the water supply guide may include a guide channel configured to connect the water supply channel and the water discharge port to each other, and the guide channel may be located between the leakage prevention protrusion and the water supply channel on the inner circumferential surface of the tub gasket.

The tub gasket may include a leakage prevention recess provided at an inwardly facing end of the inner circumferential surface of the tub gasket facing the tub, the leakage prevention recess being depressed away from the center of the tub gasket, the leakage prevention recess being configured to collect water present on the inner circumferential surface of the tub gasket, thereby preventing leakage of water into the tub.

The tub gasket may further include a water discharge portion provided at a lower end of the tub gasket, the water discharge portion being in communication with the leakage prevention recess, the water discharge portion being configured to discharge the water collected in the leakage prevention recess to the outside of the tub gasket.

The tub gasket may include a water diffusion portion protruding from the inner circumferential surface of the tub gasket, the water diffusion portion being configured to diffuse water along the inner circumferential surface of the tub gasket by the water supply guide.

The water diffusion portion may extend across the inner circumferential direction. A plurality of water diffusion portions may be configured to have a larger extension length with increasing distance from the water supply guide.

The distance between neighboring ones of the plurality of water diffusion portions may gradually decrease with increasing distance from the water supply guide.

The water diffusion portion may include an inner end facing the inside of the tub and an outer end located opposite the inner end, and the water diffusion portion may extend such that the inner end is located farther from the gasket water supply portion than the outer end.

The tub gasket may include a leakage prevention protrusion protruding from an outwardly facing end of the inner circumferential surface of the tub gasket facing the outside of the cabinet toward the center of the laundry opening, the leakage prevention protrusion extending in the inner circumferential direction, and the height of the water diffusion portion protruding from the inner circumferential surface of the tub gasket may be lower than the protruding height of the leakage prevention protrusion.

The gasket water supply portion may alternately perform a supply maintenance process in which water is supplied to the water supply guide and a supply interruption process in which the supply of water to the water supply guide is interrupted during the drying cycle.

The laundry treating apparatus may further include a flow valve provided in the cabinet, the flow valve being configured to control the flow of water provided to the gasket water supply portion and a controller provided in the cabinet, the controller being configured to control the flow valve such that the supply maintenance process and the supply interruption process of the gasket water supply portion are repeated during the drying cycle.

The laundry treating apparatus may further include a flow valve provided in the cabinet, the flow valve being configured to control the flow of water provided to the gasket water supply portion, wherein the flow valve may correspond to a constant flow valve configured to maintain a constant flow pressure of water discharged from the flow valve regardless of the flow pressure of water introduced into the flow valve.

The laundry treating apparatus may further include a heating unit provided in the cabinet, the heating unit being configured to heat air in the tub during the drying cycle, wherein the tub may be heated by the heating unit in a stagnant state of air therein during the drying cycle and may be dehumidified by contact with the tub gasket.

The heating unit may provide an electromagnetic field from the outside of the tub to the inside of the tub, and the drum may be heated by induced current formed by the electromagnetic field, whereby air in the tub may be heated.

Meanwhile, a laundry treating apparatus according to an embodiment of the present disclosure may include a cabinet including a front plate having a laundry opening formed therein, a tub provided in the cabinet, the tub including a tub opening facing the laundry opening, a drum rotatably provided in the tub, the drum being configured to receive laundry, a tub gasket provided between the laundry opening and the tub opening, the tub gasket extending along the circumference of the laundry opening, the tub gasket being configured to seal between the laundry opening and the tub opening, a gasket water supply portion provided at the tub gasket, the gasket water supply portion being configured to receive water from the outside of the tub gasket, a water supply guide provided at the tub gasket, the water supply guide being configured to flow water delivered from the gasket water supply portion along an inner circumferential surface of the tub gasket, a flow valve configured to control the flow of water delivered to the gasket water supply portion, and a controller configured to control the flow valve such that water is supplied to the tub gasket during a drying cycle for drying laundry.

### Advantageous Effects

According to embodiments of the present disclosure, it is possible to provide a laundry treating apparatus capable of effectively removing moisture from air in a tub during a drying cycle of laundry.

In addition, according to embodiments of the present disclosure, it is possible to provide a laundry treating apparatus capable of effectively cleaning and cooling a tub gasket configured to prevent water leakage during a drying cycle.

In addition, according to embodiments of the present disclosure, it is possible to provide a laundry treating apparatus capable of effectively cleaning a tub gasket while preventing water from being delivered to laundry during a drying cycle of laundry.

In addition, according to embodiments of the present disclosure, it is possible to provide a laundry treating apparatus capable of effectively increasing the cleaning area of a tub gasket and effectively cleaning main parts to be cleaned where contaminants are likely to remain.

Furthermore, according to embodiments of the present disclosure, it is possible to provide a laundry treating apparatus capable of effectively cleaning a tub gasket in a timely manner such that contaminants are not adhered to the tub gasket due to a drying cycle of laundry.

### DESCRIPTION OF DRAWINGS

FIG. 1 is a view showing the appearance of a laundry treating apparatus according to an embodiment of the present disclosure.

FIG. 2 is a sectional view showing the inside of the laundry treating apparatus according to the embodiment of the present disclosure.

FIG. 3 is a view showing a heating unit provided in a cabinet of the embodiment of the present disclosure.

FIG. 4 is a perspective view showing a tub gasket of the laundry treating apparatus according to the embodiment of the present disclosure.

FIG. 5 is a perspective view of a water supply module provided at the tub gasket in the embodiment of the present disclosure.

FIG. 6 is a view schematically showing the water supply module separated from the tub gasket in the embodiment of the present disclosure.

FIG. 7 is a view schematically showing the water supply module mounted to the tub gasket in the embodiment of the present disclosure.

FIG. 8 is a sectional view of the tub gasket in the embodiment of the present disclosure when viewed in a lateral direction.

FIG. 9 is a view showing area A in the tub gasket of FIG. 4 when viewed from the inside of the tub gasket.

FIG. 10 is a view showing area B in the tub gasket of FIG. 4 when viewed from the inside of the tub gasket.

FIG. 11 is a view showing the state in which a water discharge channel extending from the tub gasket is connected to a drainage pump in the embodiment of the present disclosure.

FIG. 12 is a view showing the state in which the water discharge channel extending from the tub gasket is connected to a tub drainage channel of a tub in the embodiment of the present disclosure.

FIG. 13 is a view conceptually showing how the water supply module and the drainage pump are operated in the embodiment of the present disclosure.

FIG. 14 is a view showing a flow valve provided in a gasket connection channel through which water flows to the water supply module in the embodiment of the present disclosure.

### BEST MODE FOR DISCLOSURE

Now, embodiments of the present disclosure will be described in detail with reference to the accompanying drawings such that the embodiments of the present disclosure can be easily implemented by a person having ordinary skill in the art to which the present disclosure pertains.

However, the present disclosure may be implemented in many different forms and is not limited to the embodiments described herein. In order to clearly illustrate the present disclosure in the drawings, parts not pertinent to the description have been omitted, and similar parts throughout the specification have been designated by similar reference numerals.

In this specification, duplicate descriptions of the same components will be omitted.

It will be understood that, when a component is referred to as being “connected to” or “coupled to” another component in this specification, the component may be directly connected to or coupled to the other component, or intervening components may be present. In contrast, when a component is referred to as being “directly connected to” or “directly coupled to” another component, there are no intervening components present.

In addition, the terms used in this specification are provided only to explain specific embodiments, but are not intended to restrict the present disclosure.

Also, in this specification, a singular representation may include a plural representation unless it represents a definitely different meaning from the context.

It will be further understood that the terms “comprises”, “has” and the like, when used in this specification, specify the presence of stated features, numbers, steps, operations, components, parts, or combinations thereof, but do not preclude the presence or addition of one or more other features, numbers, steps, operations, components, parts, or combinations thereof.

In addition, as used herein, the term “and/or” includes any combination of a plurality of listed items or any one of the plurality of listed items. As used herein, “A or B” may include A, B, or both A and B.

When described hereinafter with reference to the drawings, X, Y, and Z directions in the drawings mean a forward-rearward direction, a lateral direction, and an upward-downward direction, respectively, but this is for the convenience of describing an example of the disclosure and does not necessarily limit the direction for each component to that shown in the drawings.

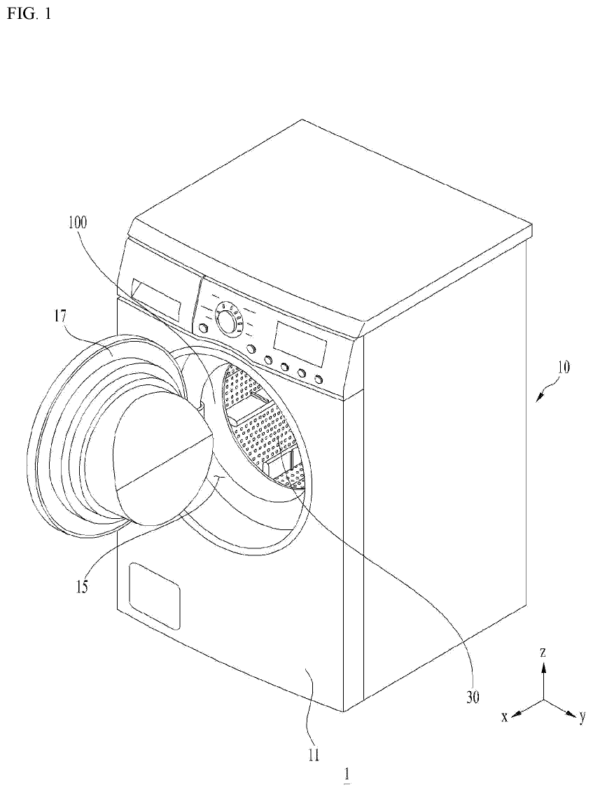

FIG. 1 is a perspective view showing the appearance of a laundry treating apparatus 1 according to an embodiment of the present disclosure. Referring to FIG. 1, the laundry treating apparatus 1 according to the embodiment of the present disclosure includes a cabinet 10, and the cabinet 10 includes a front plate 11 having a laundry opening 15 formed therein.

The cabinet 10 may be a component that defines the appearance of the laundry treating apparatus 1. The cabinet 10 may have a space defined therein, and a tub 20 and a drum 30, which will be described later, may be provided in the space.

The cabinet 10 may have various shapes, such as a cylindrical shape and a polyprismatic shape. Although FIG. 1 shows a cabinet 10 having a hexahedral shape, the present disclosure is not necessarily limited thereto, and for convenience of description, the cabinet 10 will be described hereinafter based on the hexahedral shape shown in FIG. 1 unless otherwise mentioned.

The cabinet 10 may be made of a plurality of plates joined together, molded so as to have a corresponding shape by casting, or made of a single piece of material bent or curved.

When the cabinet 10 includes a plurality of plates, the plurality of plates may include a front plate 11, a rear plate, a side plate, a lower plate, and an upper plate, and the plurality of plates may be coupled to form the cabinet 10.

FIG. 1 shows a front plate 11 including a laundry opening 15. However, this is for convenience of description, and the front plate 11 is not necessarily limited to a plate having the laundry opening 15.

The laundry opening 15 may be formed in the front plate 11. Referring to FIG. 1, the laundry opening 15 may correspond to a through-hole formed through the front plate 11, and may allow the inside and the outside of the cabinet 10 to communicate with each other therethrough. The inside of the cabinet 10 may be exposed to the outside through the laundry opening 15.

A user may introduce or withdraw laundry into or out of the cabinet 10 through the laundry opening 15. That is, the laundry opening 15 may correspond to a passageway for laundry to be moved into and out of the cabinet 10.

The tub 20 and the drum 30 may be located at the rear of the laundry opening 15, and a tub gasket 100 configured to prevent leakage of water may be provided between the tub 20 and the drum 30 and the laundry opening 15. The tub gasket 100 will be described in more detail later.

The front plate 11 may be provided with a laundry door 17 configured to open and close the laundry opening 15. The laundry door 17 may be rotatably coupled to the front plate 1, and may be brought into tight contact with the front plate 11 to close the laundry opening 15 or may be moved away from the front plate 11 to open the laundry opening 15.

Meanwhile, the cabinet 10 may be provided with a control panel that is exposed to the outside, and at least a part of a detergent supply device 80 configured to allow the user to store a detergent therein may be exposed to the outside of the cabinet 10.

The control panel may be configured to inform the user of a laundry treating process or to receive an operation signal from the user. For example, the control panel may provide various kinds of information to the user through a display, a speaker, or the like, and may receive an operation signal from the user through a microphone, a button, or the like.

In FIG. 1, the control panel and the laundry opening 15 are shown as being provided at the front plate 11 but may also be provided at the side plate or the upper plate.

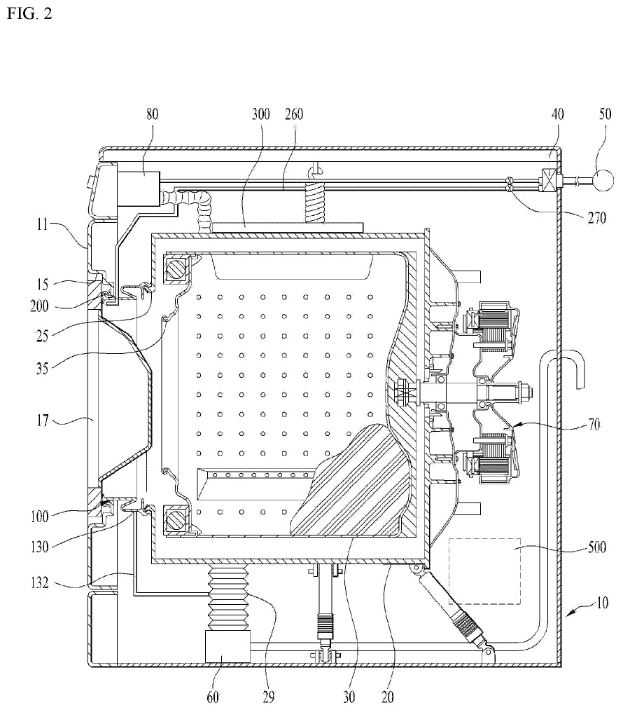

Meanwhile, FIG. 2 is a sectional view showing the inside of the laundry treating apparatus 1 according to the embodiment of the present disclosure. FIG. 2 corresponds to a view of the interior of the cabinet 10 when viewed in the lateral direction.

Referring to FIG. 2, the embodiment of the present disclosure may include a tub 20 and a drum 30 provided in the cabinet 10. The tub 20 may be installed in the cabinet 10, may receive water therein, and may include a tub opening 25 facing the laundry opening 15. The drum 30 may be rotatably installed in the tub 20, and may receive laundry therein.

FIG. 2 shows a front-loading type laundry treating apparatus 1 in which the laundry opening 15, the tub opening 25, and the drum opening 35 all face the front of the cabinet 10, but the present disclosure is not necessarily limited thereto, and for convenience of description, the following description will be based on the front-loading type laundry treating apparatus unless otherwise mentioned.

The tub 20 is provided in the cabinet 10, and may have various shapes, such as a cylindrical shape and a polyprismatic shape. For convenience of description, the following description will be based on the cylindrical tub 20.

The tub 20 may have a cylindrical shape with an approximately circular section, and may have a tub opening 25 formed in one surface excluding a circumferential surface. For example, the one surface of the tub 20 may be open such that the tub opening 25 is formed.

The tub 20 may have a space defined therein, and the inside and the outside of the tub 20 may communicate with each other through the tub opening 25. The inner space of the tub 20 may be exposed to the outside of the tub 20 through the tub opening 25.

The drum 30 is provided in the tub 20, and may have various shapes, such as a cylindrical shape and a polyprismatic shape. For convenience of description, the following description will be based on the cylindrical drum 30.

The drum 30 may have a cylindrical shape with an approximately circular section, and may have a drum opening 35 formed in one surface excluding a circumferential surface. For example, the one surface of the tub 20 may be open such that the drum opening 35 is formed.

The drum 30 may have a space defined therein, and the inside and the outside of the drum 30 may communicate with each other through the drum opening 35. The inner space of the drum 30 may be exposed to the outside of the drum 30 through the drum opening 35.

The drum 30 may be provided in the tub 20 such that the drum opening 35 faces the tub opening 25, and the tub 20 may be provided in the cabinet 10 such that the tub opening 25 faces the laundry opening 15. That is, the laundry opening 15, the tub opening 25, and the drum opening 35 may be aligned in one direction so as to face each other.

Laundry introduced into the cabinet 10 from the outside of the cabinet 10 through the laundry opening 15 may pass through the tub opening 25 and the drum opening 35 and may be received in the drum 30. That is, the tub opening 25 and the drum opening 35 may be a passageway for movement of laundry together with the laundry opening 15.

The tub 20 may receive water therein, and the drum 30 may have through-holes formed in a circumferential surface thereof. When water is supplied into the tub 20 during a treatment process for treating laundry, therefore, the water may be provided into the drum 30 through the through-holes of the drum 30, whereby the laundry and the water may come into contact with each other.

Meanwhile, the cabinet 10 may be provided therein with a water source connection unit 40 connected to an external water source 50 to receive water from the external water source 50. The external water source 50 refers to an object that supplies water from outside of the cabinet 10 to the water source connection unit 40.

The water source connection unit 40 may deliver water supplied from the external water source 50 to various components in the cabinet 10. The water source connection unit 40 may include at least one valve configured to control the flow of water as needed.

The tub 20 may be directly connected to the water source connection unit 40 via a tub 20 channel to receive water, or may receive water and a detergent from the detergent supply device 80 that receives water from the water source connection unit 40, as shown in FIG. 2.

Meanwhile, the drum 30 may be rotatably provided in the tub 20. The cabinet 10 may be provided therein with a driving unit 70 configured to provide rotational force for the drum 30, and the driving unit 70 may be provided between the tub 20 and the cabinet 10.

Referring to FIG. 2, in the embodiment of the present disclosure, the driving unit 70 may be installed on the rear surface of the tub 20, the drum 30 may be coupled to a rotary shaft extending through the tub 20, and the driving unit 70 may provide rotational force to the drum 30 via the rotary shaft.

Meanwhile, the tub gasket 100 may be provided between the tub 20 and the front plate 11. When water is provided into the tub 20 for a treatment process of laundry, such as a washing cycle or a rinsing cycle, the water in the tub 20 may flow to the outside of the cabinet 10 or to the inside of the cabinet 10 and the outside of the tub 20 through the tub opening 25.

If the water in the tub 20 flows to the outside of the tub 20, the other components may be corroded or deteriorated, hygiene may be reduced, and other components may malfunction.

In the embodiment of the present disclosure, therefore, the tub gasket 100 configured to prevent the water in the tub 20 from flowing to the outside of the tub 20 may be provided between the front plate 11, in which the laundry opening 15 is formed, and the tub 20. The tub gasket 100 will be described in detail later.

Meanwhile, FIG. 2 shows a water supply module 200 provided at the tub gasket 100. The water supply module 200 may be configured to supply water to the tub gasket 100, and the water provided to the tub gasket 100 may be used for various purposes, such as cleaning.

The water supply module 200 may receive water from the water source connection unit 40 via a gasket connection channel 260, and the gasket connection channel 260 may be provided with a flow valve 270 configured to control the flow of water.

Meanwhile, the cabinet 10 may be provided therein with a heating unit 300 coupled to the tub 20 to heat the inside of the tub 20, and a detailed description of the heating unit 300 will follow.

Meanwhile, a drainage hole configured to discharge water may be provided in the tub 20, and water provided in the tub 20 may be discharged to the outside of the tub 20 through the drainage hole as needed.

For example, the drainage hole of the tub 20 may be connected to a drainage pump 60 via a tub drainage channel 29, and the drainage pump 60 may be operated as needed to discharge water in the tub 20 to the outside.

The tub gasket 100 configured to receive water from the water supply module 200 may also be provided with a water discharge portion 130 configured to discharge water, and the water discharge portion 130 may include a through-hole configured to allow water present in the tub gasket 100 to be discharged therethrough.

The through-hole of the water discharge portion 130 may be connected to a water discharge channel 132, and the water discharged from the tub gasket 100 through the water discharge portion 130 may flow along the water discharge channel 132, may pass through the drainage pump 60, and may be discharged.

Meanwhile, the laundry treating apparatus 1 according to the embodiment of the present disclosure may include a controller 500. The controller 500 may be provided in or outside the cabinet 10, and may be electrically/signally connected to the water source connection unit 40, the flow valve 270, the detergent supply device 80, the driving unit 70, and the drainage pump 60.

That is, the controller 500 may be connected to various components that are electrically/electronically controllable in the embodiment of the present disclosure, and may be configured to control the operating state of the various components and to perform the washing cycle or the drying cycle of laundry.

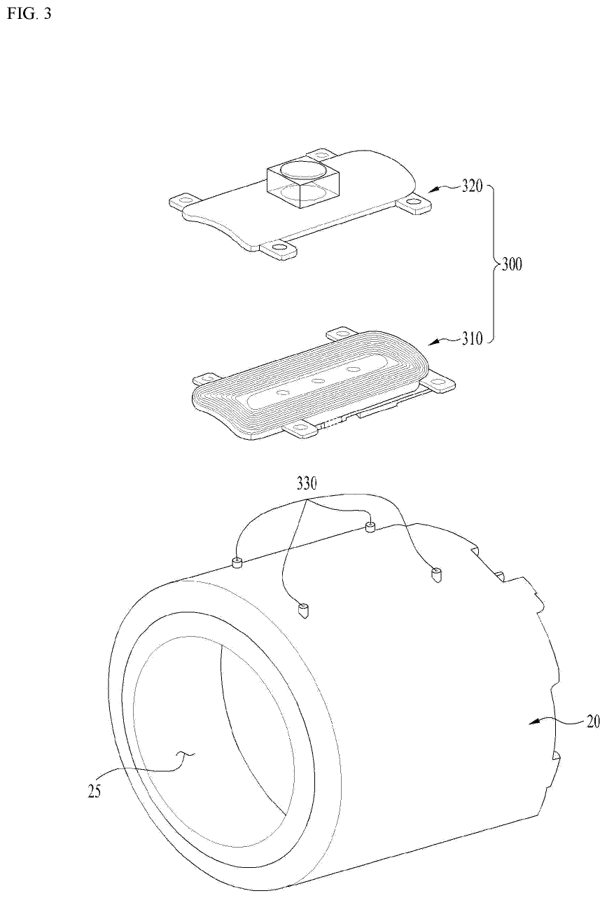

Meanwhile, FIG. 3 shows a heating unit 300 of the embodiment of the present disclosure. The heating unit 300 may be configured to heat water or air by heating the inside of the tub 20. For example, the heating unit 300 may be configured to increase the temperature of the water during the washing cycle or to increase the temperature of the air present in the tub 20 during the drying cycle.

The heating unit 300 may be provided in various types and shapes. For example, the heating unit 300 may be provided in the form of a heat pump system using a refrigerant, may be provided in the form of an electric heater that is heated by resistance due to electric current, or may be provided in the form of an electromagnetic field generator that generates an electromagnetic field to generate induced current in a target, thereby heating the target by electrical resistance.

FIG. 3 shows a heating unit 300 in the form of an electromagnetic field generator according to an embodiment of the present disclosure. Referring to FIG. 3, the heating unit 300 may include an induction coil 310 and a coil cover 320, and the tub 20 may be provided with a coil coupling portion 330 to which the heating unit 300 is coupled.

The induction coil 310 may be configured to generate an electromagnetic field when current is provided, and may be shielded from the outside by the coil cover 320. The induction coil 310 may be provided on an outer circumferential surface of the tub 20 to provide an electromagnetic field into the tub 20.

The tub 20 may be made of a material that does not generate induced current, e.g., a nonconductor, such as plastic. Consequently, an electromagnetic field provided by the heating unit 300 including the induction coil 310 does not affect the tub 20, and the electromagnetic field may be provided into the tub 20.

Meanwhile, the drum 30 may be made of a material that generates induced current, e.g. a conductor, such as metal or special ceramic, unlike the tub 20. Consequently, induced current, such as eddy current, may be formed in the drum 30 by the electromagnetic field provided by the heating unit 300. With the formation of current, the drum 30, which corresponds to a resistor, may be heated.

The drum 30, which is heated by the heating unit 300, may contribute to increasing the temperature of air or water in the tub 20. For example, the heating unit 300 may heat the drum 30 to increase the temperature of washing water provided in the tub 20 during the washing cycle of laundry, or may heat the drum 30 to increase the temperature of the air in the tub 20 during the drying cycle of laundry. In the embodiment of the present disclosure, the controller 500 may be electrically/signally connected to the heating unit 300 to control the operation of the heating unit 300.

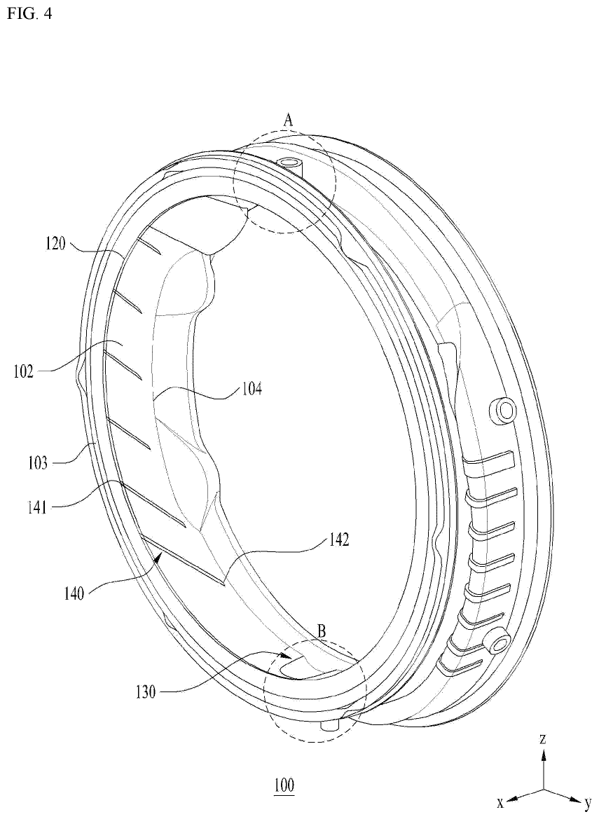

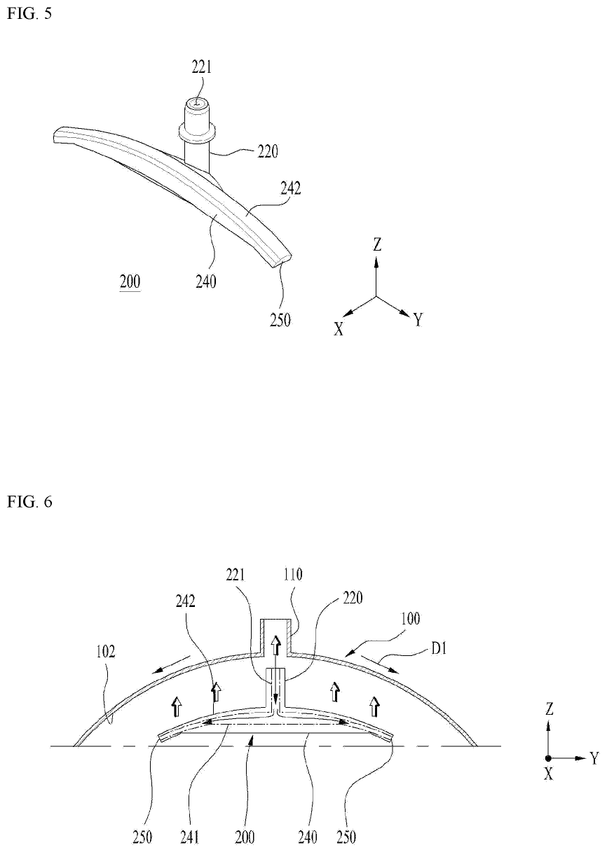

Meanwhile, FIG. 4 shows a tub gasket 100 according to an embodiment of the present disclosure, and FIG. 5 is a perspective view of a water supply module 200 provided at the tub gasket 100.

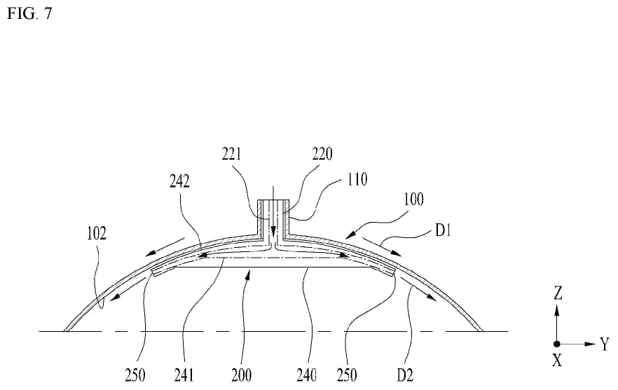

In addition, FIG. 6 schematically shows the water supply module 200 before mounting thereof to the tub gasket 100, and FIG. 7 schematically shows the state in which the water supply module 200 of FIG. 6 is mounted to the tub gasket 100.

In the embodiment of the present disclosure, the tub gasket 100 may be provided in the cabinet 10, may extend along the circumference of the laundry opening 15 such that an inner circumferential surface 102 faces the center of the laundry opening 15, and may seal between the laundry opening 15 and the tub gasket 25.

In addition, the water supply module 200 may be provided at the tub gasket 100 to supply water to the inner circumferential surface 102 of the tub gasket 100.

Referring to FIGS. 4 to 7, the tub gasket 100 may be provided between the tub 20 and the front plate 11 in the cabinet 10. The turbo gasket 100 may be configured in the shape of a ring extending along the circumference of the tub opening 25 or the laundry opening 15.

An opening region formed inside the tub gasket 100 may have a shape corresponding to the laundry opening 15 or the tub opening 25, and may be configured to connect the laundry opening 15 and the tub opening 25 to each other between the laundry opening 15 and the tub opening 25.

The inner circumferential surface 102 of the tub gasket 100 may face the center of the laundry opening 15 or the tub opening 25, and the tub gasket 100 may seal between the front plate 11 and the tub 20, i.e., between the laundry opening 15 and the tub opening 25, such that water does not leak from the inside to the outside of the tub gasket 100.

The tub gasket 100 may be coupled and fixed to the front plate 11 and/or the tub 20. The tub gasket 100 may seal between the front plate 11 and the tub 20 to prevent water present in the tub 20 from leaking out of the tub 20.

The water supply module 200 may be provided at the tub gasket 100 to supply water to the inner circumferential surface 102 of the tub gasket 100. The water supplied from the water supply module 200 may be cleaning water for cleaning the tub gasket 100 or coolant for cooling the tub gasket 100 during the drying cycle.

The water supply module 200 may include a gasket water supply portion 220 and a water supply guide 240, which will be described later. The gasket water supply portion 220 and the water supply guide 240 may be configured as a single module or may be separately provided.

The laundry treating apparatus 1 according to the embodiment of the present disclosure may perform various cycles for treating laundry. For example, the laundry treating apparatus 1 according to the embodiment of the present disclosure may perform a washing process for washing laundry, wherein the washing process may include at least one of a washing cycle, a rinsing cycle, a spin-drying cycle, and a drying cycle.

The washing cycle is a cycle in which water and detergent are supplied into the tub 20 to remove contaminants from laundry, the rinsing cycle is a cycle in which water is supplied into the tub 20 to remove residual foreign matter from laundry, the spin-drying cycle is a cycle in which moisture present in laundry is physically separated from the laundry, and the drying cycle is a cycle in which moisture present in laundry is removed by evaporating the water.

The washing process and the plurality of cycles may be performed by the controller 500. The controller 500 may perform the plurality of cycles by controlling the driving unit 70, the water source connection unit 40, the drainage pump 60, and the like so as to correspond to an option value preset for each of the plurality of cycles or set by a user.

Meanwhile, during the washing process, contaminants, dust, foreign matter, or detergent present in laundry may be present in the tub 20, and the contaminants or the like may be delivered to the tub gasket 100 along with the water.

The contaminants or the like delivered to the tub gasket 100 may still remain in the tub gasket 100 even after finish of the washing process or each cycle, and the contaminants or the like remaining in the tub gasket 100 may cause corrosion or deterioration of the tub gasket 100, may reduce hygiene of the apparatus 1, and may reduce washing efficiency during a subsequent washing process of laundry.

In addition, the contaminants or the like are likely to remain on the inner circumferential surface 102 of the tub gasket 100 exposed to the tub opening 25, and therefore, in the embodiment of the present disclosure, the water supply module 200 may be provided at the tub gasket 100, the water supply module 200 may supply water to the inner circumferential surface 102 of the tub gasket 100 to clean the inner circumferential surface 102 of the tub gasket 100 in a situation where cleaning of the tub gasket 100 is required.

The supply of water by the water supply module 200 may be controlled by the controller 500. That is, the flow of water introduced into the gasket water supply portion 220 may be adjusted by the controller 500.

For example, the controller 500 may preset the point in time when the cleaning process of the tub gasket 100 by the water supply module 200 is required during the washing process of laundry, and may control the flow valve 270 such that water flows to the inner circumferential surface 102 of the tub gasket 100 through the water supply module 200 during the cleaning process of the tub gasket 100.

Meanwhile, the water supply module 200 may include a water discharge port 250, through which water is discharged, and water may be discharged from the water discharge port 250 in parallel to an inner circumferential direction D1 of the tub gasket 100.

In the water supply module 200, the gasket water supply portion 220 may receive water from the water source connection unit 40 through the gasket connection channel 260, and the water supply guide 240 may include a water discharge port 250 through which water delivered from the gasket water supply portion 220 is discharged toward the inner circumferential surface 102 of the tub gasket 100.

Water may be discharged in parallel to the inner circumferential direction D1 of the tub gasket 100 or may be discharged toward the inner circumferential surface 102 through the water discharge port 250. That is, the discharge direction D2 of water in the water discharge port 250 may be parallel to the inner circumferential direction D1. In FIG. 5, the discharge direction D2 of water and the inner circumferential direction D1 of the tub gasket 100 are shown.

Here, the inner circumferential direction D1 of the tub gasket 100 may refer to a tangential direction defined on the inner circumferential surface 102 of the tub gasket 100 at the point where the water discharge port 250 is located. However, considering design or manufacturing tolerances of the actual water supply module 200, it may be understood that the discharge direction D2 of water is substantially the same as the inner circumferential direction D1.

For example, water discharged from the water discharge port 250 may have a tolerance of about 5 degrees, 10 degrees, or 20 degrees with respect to the tangential direction to the inner circumferential surface 102 at the point where the water discharge port 250 is located.

In the embodiment of the present disclosure, the discharge direction D2 of water in the water discharge port 250 is set in parallel to the inner circumferential direction D1 of the tub gasket 100 such that water discharged from the water discharge port 250 flows along the inner circumferential surface 102 of the tub gasket 100, whereby the cleaning area is increased.

Referring to FIGS. 6 and 7, in the embodiment of the present disclosure, the laundry opening 15 of the front plate 11 may be formed in the front surface of the cabinet 10, and the water supply module 200, i.e., the gasket water supply portion 220 and the water supply guide 240, may be located at an upper part of the tub gasket 100.

For example, the water supply guide 240 of the water supply module 200 may be located at the upper part of the tub gasket 100. The upper part of the tub gasket 100 may refer to the half of the tub gasket 100 located above the center of the tub gasket 100.

When water is discharged from the water supply guide 240 of the water supply module 200 located at the upper part of the tub gasket 100 in the inner circumferential direction D1 of the tub gasket 100, the water may clean the entire inner circumferential surface 102 of the tub gasket 100 while flowing therealong by the initial flow energy, centrifugal force, and weight of the water. That is, the cleaning area and the cooling area by the water provided from the water supply module 200 may be maximized.

However, the description of the embodiment of the present disclosure with reference to FIGS. 6 and 7 is only for illustrative purposes, and the front plate 11 is not necessarily the front plate, and the water supply module 200 or the water supply guide 240 is not necessarily located at the upper part of the tub gasket 100.

In the embodiment of the present disclosure, the water discharge direction D2 of the water supply module 200 or the water supply guide 240 may be formed parallel to the inner circumferential direction D1 of the tub gasket 100, whereby the flow area, i.e., the cleaning area, of the water discharged from the water supply module 200 may be effectively increased to effectively clean the tub gasket 100 and to increase the condensation effect by cooling during the drying cycle.

Meanwhile, in the embodiment of the present disclosure, the water supply module 200 may supply water to the inner circumferential surface 102 of the tub gasket 100 during the drying cycle for drying laundry. During the drying cycle, water from the outside of the tub gasket 100 may be introduced into the gasket water supply portion 220, and the water supply guide 240 may be connected to the gasket water supply portion 220 to guide water received from the gasket water supply portion 220 along the inner circumferential surface 102 of the tub gasket 100.

During the drying cycle, the tub gasket 100 may be cooled by water supplied from the water supply module 200, and moisture contained in heated air in the tub 20 may be condensed on the inner circumferential surface 102 to generate condensate.

During the drying cycle of laundry, hot air may be provided into the tub 20. The hot air may be provided into the tub 20 through a circulating, exhaust, or stagnant structure, as will be described later.

During the drying cycle, moisture of the laundry may be evaporated and contained in the air by hot, low-humidity air present in the tub 20. The laundry treating apparatus 1 according to the embodiment of the present disclosure may dry the laundry by removing the moisture in the air during the drying cycle.

In the embodiment of the present disclosure, the tub gasket 100 may be cooled by water provided by the water supply module 200 during the drying cycle, and as hot air present in the tub 20 comes into contact with the tub gasket 100, moisture in the air may be condensed on the surface of the tub gasket 100 to generate condensate.

That is, in the embodiment of the present disclosure, the inner circumferential surface 102 of the tub gasket 100 may be cleaned through the water supply module 200, and at the same time the tub gasket 100 may be cooled using water provided from the water supply module 200 during the drying cycle, whereby the dehumidification effect of the air may be achieved.

In the embodiment of the present disclosure, therefore, the tub gasket 100 is cooled while the tub gasket 100 is cleaned, whereby it is possible to effectively remove moisture in the air during the drying cycle. In the embodiment of the present disclosure, a separate configuration configured to remove moisture in the air may not be provided outside the tub 20, which may simplify the structure in the cabinet 10 and greatly improve space utilization.

Meanwhile, in the embodiment of the present disclosure, the water supply guide 240 may supply water to the inner circumferential surface 102 of the tub gasket 100 to flow the water. That is, the water supply guide 240 may flow water toward or parallel to the inner circumferential surface 102 of the tub gasket 100.

In the embodiment of the present disclosure, the water supply module 200 may be a means configured to cool the tub gasket 100 during the drying cycle, and the water supply module 200 may provide water to the tub gasket 100 during the drying cycle to cool the tub gasket 100.

However, if water provided to the tub gasket 100 from the water supply module 200 splashes or splatters back onto the laundry in the drum, moisture may be delivered back to the laundry being dried, thereby reducing the drying efficiency.

In the embodiment of the present disclosure, therefore, the water supply guide 240 supplies water to the inner circumferential surface 102 of the tub gasket 100 to inhibit water splashing in order to effectively clean and cool the tub gasket 100 during the drying cycle while preventing delivery of water to the laundry.

Meanwhile, the embodiment of the present disclosure may further include a heating unit 300 provided in the cabinet 10, as described above, the heating unit being configured to heat air in the tub 20 during the drying cycle, and the tub 20 may be heated by the heating unit 300 in a stagnant state of air therein during the drying cycle and may be dehumidified by contact with the tub gasket 100.

That is, in the embodiment of the present disclosure, it is possible to effectively heat and dehumidify air in the tub 20 through the heating unit 300 that heats air in the tub 20 and the tub gasket 100 that removes moisture from the air in the tub 20 even though the drying cycle is performed through a stagnant structure while omitting a structure that circulates the air in the tub 20 during the drying cycle.

Meanwhile, in the embodiment of the present disclosure, at least a part of the water supply module 200 may extend in the inner circumferential direction D1 of the tub gasket 100 such that water is discharged in parallel with the inner circumferential direction D1.

Specifically, in the embodiment of the present disclosure, the water discharge direction D2 of the water discharge port 250 may be designed using a variety of methods. For example, in the embodiment of the present disclosure, the water discharge unit direction D2 may be set parallel to the inner circumferential direction D1 by manufacturing the water supply module 200 such that the open direction of the water discharge port 250 is the same as the inner circumferential direction D1.

Furthermore, in the embodiment of the present disclosure, the water supply module 200 may be at least partially disposed on the inner circumferential surface 102 of the tub gasket 100, and may extend in the inner circumferential direction D1 of the tub gasket 100.

Water supplied from the water source connection unit 40 may be introduced into the gasket water supply portion 220, and the water introduced into the gasket water supply portion 220 may be delivered to the water supply guide 240 and may flow in the extension direction of the water supply guide 200.

As at least a part of the water supply guide 240 extends in parallel to the inner circumferential direction D1 of the tub gasket 100, conformity between the discharge direction D2 of water and the inner circumferential direction D1 of the tub gasket 100 may be improved, the loss of flow energy of water flowing through the interior of the water supply guide 240 and discharged through the water discharge port 250 may be minimized, and the cleaning area may be effectively increased.

FIG. 7 shows the water supply guide 240 provided on the inner circumferential surface 102 of the tub gasket 100 while at least a part of the water supply guide extends in the inner circumferential direction D1 of the tub gasket 100 in accordance with the embodiment of the present disclosure.

Meanwhile, in the embodiment of the present disclosure, the front plate 11 may form the front of the cabinet 10, and at least a part of the water supply module 200 may be located at an upper end of the inner circumferential surface 102 of the tub gasket 100.

When the front plate 11 forms the front of the cabinet 10, as described above, and the laundry opening 15 is formed in the front of the cabinet 10, the water supply module 200 may be located at the upper end of the tub gasket 100, thereby maximizing the rate of increase of the cleaning area by the water supply module 200.

In the embodiment of the present disclosure, however, the center of the water supply module 200, the gasket water supply portion 220, or the water supply guide 240 needs not necessarily be located at the uppermost end of the tub gasket 100, and a part of the water supply module 200 may be located at the upper end of the tub gasket 100.

Meanwhile, the embodiment of the present disclosure may include a heating unit 300. The heating unit 300 may be provided in the cabinet 10 and may heat the inside of the tub 20 for the drying cycle of laundry. The water supply module 200 may be configured to discharge water to the tub gasket 100 before or during operation of the heating unit 300.

Specifically, the embodiment of the present disclosure may include a heating unit 300 as described above, and the heating unit 300 may heat the inside of the tub 20 in various ways. The heating unit 300 may be operated to perform the drying cycle of laundry to heat the inside of the tub 20. The operation of the heating unit 300 may be by the controller 500.

That is, the controller 500 may operate the heating unit 300 to heat the inside of the tub 20 during the drying cycle. In addition, the heating unit 300 may heat various objects, such as air in the tub 20 or the drum 30, as described above.

In the embodiment of the present disclosure, the heating unit 300 may be operated to perform the drying cycle of laundry, and when the drying cycle of laundry is performed, the water present in the tub 20 may evaporate and phase change to moisture in the air.

During the drying cycle, contaminants present in the tub gasket 100 along with water may be adhered to the surface of the tub gasket 100 with evaporation of the water, and furthermore, depending on the type of laundry, lint or the like of the laundry may be dispersed into the air by evaporation of moisture contained in the laundry during the drying cycle and may be located on the inner circumferential surface 102 of the tub gasket 100.

As such, the negative effects of contaminants present on the tub gasket 100 may be exacerbated through the drying cycle of laundry, and therefore, in the embodiment of the present disclosure, water may be discharged to the tub gasket 100 before or during operation of the heating unit 300. In addition, water may be discharged after operation of the heating unit 300 is finished, as needed.

In addition, as described above, the water supply module 200 may periodically supply water to the inner circumferential surface 102 of the tub gasket 100 for cooling of the tub gasket 100 during the drying cycle and consequent dehumidification of the air.

The temporal relationship between the operation of the heating unit 300 and the operation of the gasket water supply portion 220 may be preset in the controller 500. The controller 500 may preset the timing of operation of the gasket water supply portion 220 reflecting theoretical, experimental, statistical, or strategic reasons during the washing process of laundry or the drying cycle of laundry, and the controller 500 may control the flow valve 270 to an open state to discharge water from the gasket water supply portion 220 in the state in which the operation of the gasket water supply portion 220 is required.

Meanwhile, in the embodiment of the present disclosure, the heating unit 300 may provide an electromagnetic field to the drum 30 to form an induced current in at least a part of the drum 30, thereby heating the drum 30, as described above. In the embodiment of the present disclosure, however, the heating unit 300 is not necessarily limited to the electromagnetic field generator type.

In addition, the water supply module 200 may supply water to the inner circumferential surface 102 of the tub gasket 100 while the heating unit 300 is operated to perform the drying cycle of laundry.

While the heating unit 300 is operated, the temperature of the tub gasket 100 is lowered by water provided by the water supply module 200, and air in the tub 20 with increased humidity may be condensed in the form of water droplets while contacting the tub gasket 100 at the low temperature and collected in a leakage prevention recess 150 or the water discharge portion 130, a description of which will follow.

In the embodiment of the present disclosure, at least a part of the tub gasket 100 may be cooled using the water supply module 200 during the drying cycle of laundry, thereby condensing and collecting moisture of the air in the tub 20.

Meanwhile, as described above, in the embodiment of the present disclosure, during the drying cycle, the inside of the tub 20 may be heated by the heating unit 300 while air in the tub is stagnant, and moisture in the air heated in the at least a part of the tub may be condensed.

The drying cycle of laundry may be categorized into circulation type, exhaust type, and stagnation type. The circulation type means that air is heated and dehumidified in the cabinet 10, supplied into the tub 20, and is heated and dehumidified outside the tub 20.

The exhaust type means that air outside the cabinet 10 is heated and supplied into the tub 20 and the air in the tub 20 is discharged to the outside of the cabinet 10. The stagnation type means that air in the tub 20 is heated and dehumidified in a state of being stagnant in the tub 20 without flowing.

The circulation type and the exhaust type are easy to implement because the heating or dehumidification of air is performed outside the tub 20, but a means configured to heat or dehumidify the air outside the tub 20 must be provided, which is disadvantageous in securing space and disadvantageous in design.

On the other hand, the stagnation type has an advantage of space utilization in the cabinet 10 and a design advantage since it is not necessary to provide a means configured to heat or dehumidify air outside the tub 20, but technical difficulty is high since heating and dehumidification of air must be performed in the tub 20.

In the embodiment of the present disclosure, it is possible to perform a stagnant drying cycle of laundry in which heating and dehumidification of stagnant air in the tub 20 are performed through the heating unit 300, which has safety and heating efficiency by using induced current, and the water supply module 200, which can effectively dehumidify air in the tub 20 by using coolant, as described above.

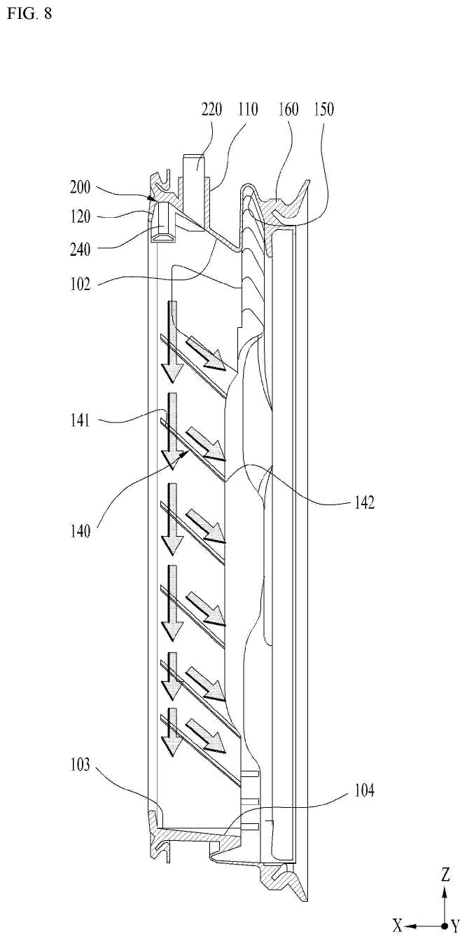

Meanwhile, FIG. 8 is a sectional view of the tub gasket 100 in the embodiment of the present disclosure when viewed in the lateral direction.

Referring to FIG. 8, the embodiment of the present disclosure may include the water source connection unit 40. The water source connection unit 40 may be provided at the cabinet 10, and may be connected to the external water source 50 to receive water.

The water supply module 200 may include a gasket water supply portion 220. The gasket water supply portion 220 may extend through the inner circumferential surface 102 of the tub gasket 100 toward the outer side of the tub gasket 100, and may be connected with the water source connection unit 40 to receive water.

The water discharge port 250 of the water supply guide 240, through which water is supplied to the tub gasket 100, may be located on the inner circumferential surface 102 of the tub gasket 100, and the water supply module 200 may include a gasket water supply portion 220 extending through the tub gasket 100 to receive water from outside the tub gasket 100.

The gasket water supply portion 220 may extend to the outside of the tub gasket 100 through the inner circumferential surface 102 of the tub gasket 100, and may be connected to the gasket connection channel 260 to receive water to be provided to the tub gasket 100 from the water source connection unit 40.

Meanwhile, the tub gasket 100 may include a protruding support portion 110. The protruding support portion 110 may protrude toward the outside of the tub gasket 100, may allow the gasket water supply portion 220 to extend therethrough, and may surround at least a part of the gasket water supply portion 220.

Specifically, the gasket water supply portion 220 may have an approximately tubular shape and may extend through the tub gasket 100. The gasket water supply portion 220, which extends to be exposed on an outer circumferential surface of the tub gasket 100, may be structurally fixed and supported by the protruding support portion 110.

The protruding support portion 110 may be configured to allow the gasket water supply portion 220 to extend therethrough, and may extend from the outer circumferential surface of the tub gasket 100 so as to protrude outward. The extension direction of the protruding support portion 110 and the extension direction of the gasket water supply portion 220 may be the same.

The water supply module 200 needs to be stably fixed to supply water to the inner circumferential surface 102 of the tub gasket 100, and furthermore the gasket water supply portion 220 connected to the gasket connection channel 260 needs to be stably fixed and supported.

To this end, in the embodiment of the present disclosure, the gasket water supply portion 220 may be stably fixed to and supported by the outer circumferential surface of the tub gasket 100 such that stable connection between the gasket water supply portion 220 and the gasket connection channel 260 is achieved.

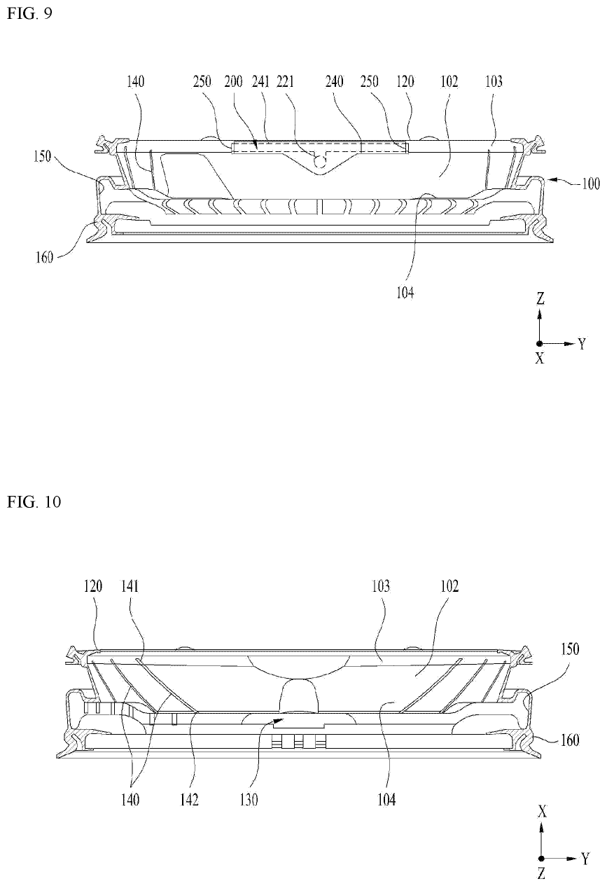

Meanwhile, FIG. 9 shows area A of FIG. 4 when viewed from the inside of the tub gasket 100. Referring to FIG. 9, in the embodiment of the present disclosure, the water supply module 200 may include a water supply guide 240.

The water supply guide 240 may be connected to the gasket water supply portion 220, at least a part of the water supply guide may extend on the inner circumferential surface 102 of the tub gasket 100 in the inner circumferential direction D1, and the water supply guide may include a water discharge port 250. In addition, the water discharge port 250 may be formed at each end of the water supply guide 240 in the extension direction of the water supply guide 240.

Specifically, the gasket water supply portion 220 of the water supply module 200 may extend from the inner circumferential surface 102 to the outer circumferential surface of the tub gasket 100 so as to be connected to the water source connection unit 40.

The gasket water supply portion 220 may be formed by a part of the tub gasket 100 or a part of the water supply module 200, and the gasket water supply portion 220 may be manufactured separately from the tub gasket 100 and the water supply module 200.

The water supply guide 240 may be provided on the inner circumferential surface 102 of the tub gasket 100 to discharge water in the inner circumferential direction D1 of the tub gasket 100.

The gasket water supply portion 220 may directly discharge water to the inner circumferential surface 102 of the tub gasket 100, or may be connected to the water supply guide 240 to deliver water to the water supply guide 240.

The water supply guide 240 may guide the flow of water provided to the inner circumferential surface 102 of the tub gasket 100 by the gasket water supply portion 220, or may guide the flow direction of water delivered from the gasket water supply portion 220 such that the water is provided to the inner circumferential surface 102 of the tub gasket 100.

In the water supply module 200, the gasket water supply portion 220 and the water supply guide 240 may be connected to each other, and water delivered from the gasket water supply portion 220 may be delivered to the water supply guide 240 and discharged to the inner circumferential surface 102 of the tub gasket 100.

The water supply module 200 may include a connection portion configured to connect the water supply guide 240 and the gasket water supply portion 220 to each other. FIG. 9 shows the water supply guide 240 extending in the inner circumferential direction D1 of the tub gasket 100 and the connection portion extending from the water supply guide 240 toward the gasket water supply portion 220. The connection portion may be configured in a shape having a width gradually decreasing from the water supply guide 240 to the gasket water supply portion 220.

Meanwhile, the water discharge port 250 may be formed at any of various positions of the water supply guide 240. FIG. 9 shows the water supply module 200 configured such that the water discharge port 250 is provided at each of both ends of the water supply guide 240 extending in the inner circumferential direction D1 of the tub gasket 100, whereby water is discharged from both sides.

Meanwhile, in the embodiment of the present disclosure, the water supply guide 240 may have an outer circumferential surface 242 facing the inner circumferential surface 102 of the tub gasket 100 in contact with the inner circumferential surface 102 of the tub gasket 100. FIGS. 7 to 9 shows the water supply module 200 in which the outer circumferential surface 242 of the water supply guide 240 is in contact with the inner circumferential surface 102 of the tub gasket 100.

At least a part of the water supply guide 240 may be in contact with the inner circumferential surface 102 of the tub gasket 100, or the entirety of the water supply guide may be in tight contact with the inner circumferential surface 102 of the tub gasket 100. In the embodiment of the present disclosure, the water supply guide 240 may be disposed in contact with the inner circumferential surface 102 of the tub gasket 100 such water discharged from the water discharge port 250 of the water supply guide 240 can be easily provided to the inner circumferential surface 102 of the tub gasket 100 without interference or collision with the flow direction.

Meanwhile, the outer circumferential surface 242 of the water supply guide 240 facing the inner circumferential surface 102 of the tub gasket 100 may have a curvature corresponding to the inner circumferential surface 102 of the tub gasket 100 so as to be easily brought into contact or tight contact with the inner circumferential surface 102 of the tub gasket 100.

FIG. 7 shows the state in which the outer circumferential surface 242 of the water supply guide 240 and the inner circumferential surface 102 of the tub gasket 100 have corresponding shapes and the water supply guide 240 is in tight contact with the inner circumferential surface 102 of the tub gasket 100 in accordance with the embodiment of the present disclosure.

Meanwhile, in the embodiment of the present disclosure, the tub gasket 100 may include a leakage prevention protrusion 120. The leakage prevention protrusion 120 may protrude from an outwardly facing end 103 of the inner circumferential surface 102 of the tub gasket 100 that faces the outside of the cabinet 10 toward the center of the laundry opening 15, may extend in the inner circumferential direction D1, and may contact the water supply guide 240.

FIG. 4 shows the leakage prevention protrusion 120 when viewed from the outside of the cabinet 10, and FIGS. 8 and 9 are sectional views of the leakage prevention protrusion 120.

The leakage prevention protrusion 120 may be provided on the outwardly facing end 103 of the inner circumferential surface 102 of the tub gasket 100 that faces the outside of the cabinet 10, may protrude toward the center side of the laundry opening 15, and may have the shape of a ring extending along the circumference of the laundry opening 15.

The leakage prevention protrusion 120 may protrude closer to the center of the laundry opening 15 than the inner circumferential surface 102 of the tub gasket 100, and therefore water present on the inner circumferential surface 102 of the tub gasket 100 may be blocked from flowing toward the outside of the cabinet 10, i.e., the laundry door 17, by the leakage prevention protrusion 120, thereby preventing water leakage.

The water supply guide 240 may be disposed in contact with the inner circumferential surface 102 of the tub gasket 100 and at the same time in contact with the leakage prevention protrusion 120. That is, the water supply guide 240 may be inserted into an edge formed by the inner circumferential surface 102 of the tub gasket 100 and the leakage prevention protrusion 120.

Contaminants or the like generated during the washing process of laundry are likely to accumulate in narrow gaps, and thus the edge between the inner circumferential surface 102 and the leakage prevention protrusion 120 of the tub gasket 100 corresponds to a main part to be cleaned where the contaminants or the like are likely to accumulate.

In the embodiment of the present disclosure, the water supply guide 240 is disposed in contact or tight contact with the leakage prevention protrusion 120 such that water discharged from the water discharge port 250 of the water supply guide 240 can effectively clean the edge formed between the leakage prevention protrusion 120 and the inner circumferential surface 102 of the tub gasket 100.

Furthermore, since the leakage prevention protrusion 120 is provided on the outwardly facing end 103 of the inner circumferential surface 102 of the tub gasket 100, which is opposite the drum 30, the water supply module 200 in contact with the leakage prevention protrusion 120 may be located on the inner circumferential surface 102 of the tub gasket 100 so as to be farthest from the drum 30, thereby effectively inhibiting water from being delivered to the drum 30.

Meanwhile, an inwardly facing end 104 of the inner circumferential surface 102 of the tub gasket 100 facing the tub 20 may be provided with a leakage prevention recess 150 configured to collect water in order to prevent water from returning from the inner circumferential surface 102 of the tub gasket 100 to the inside of the tub 20, and an end of the leakage prevention recess 150 facing the tub 20 may be provided with a tub connection portion 160 coupled to an end of the circumferential surface of the tub 20 forming the circumference of the tub opening 25.

The leakage prevention recess 150 may be provided in the inwardly facing end 104 of the inner circumferential surface 102 of the tub gasket 100 facing the tub 20 and may be depressed away from the center of the tub gasket 100, whereby water present on the inner circumferential surface 102 of the tub gasket 100 may be collected and leakage of water into the tub 20 may be prevented.

Referring to FIG. 10, in the embodiment of the present disclosure, the leakage prevention recess 150 may have the shape of a recess depressed so as to be farther from the center of the tub gasket 100 than the inner circumferential surface 102 of the tub gasket 100, and may have a closed section extending in the inner circumferential direction D1 of the tub gasket 100.

Meanwhile, the tub connection portion 160 may have a coupling recess into which a tip end of the circumferential surface of the tub 20 surrounding the tub opening 25 may be inserted, and coupling between the tub connection portion 160 and the tip end of the tub 20 may stably fix the tub gasket 100 and effectively prevent water from leaking between the tub 20 and the tub gasket 100.

Meanwhile, in the embodiment of the present disclosure, the gasket water supply portion 220 may include a water supply channel 221 through which water supplied from the water source connection unit 40 flows, the water supply guide 240 includes a guide channel 241 which is connected to the water supply channel 221 and through which water flows toward the water discharge port 250, and the guide channel 241 may be located between the leakage prevention protrusion 120 and the water supply channel 221 on the inner circumferential surface 102 of the tub gasket 100. In FIGS. 8 and 10, the water supply channel 221 and the guide channel 241 of the water supply module 200 are shown as dotted lines.

As described above, in the embodiment of the present disclosure, the water supply guide 240 may be disposed in contact with the leakage prevention protrusion 120 for effective cleaning of the edge formed between the leakage prevention protrusion 120 and the inner circumferential surface 102 of the tub gasket 100. If the front plate 11 corresponds to a front plate, the water supply guide 240 may be located at a front end of the tub gasket 100.

It is necessary for the tub gasket 100 to have an open area, through which the gasket water supply portion 220 of the water supply module 200 extends, and the water supply channel 221 of the gasket water supply portion 220 may be located farther from the leakage prevention protrusion 120 than the guide channel 241 of the water supply guide 240 such that the water supply guide 240 is easily brought into tight contact with the leakage prevention protrusion 120.

Meanwhile, in the embodiment of the present disclosure, the tub gasket 100 may include a water diffusion portion 140. The water diffusion portion 140 may protrude from the inner circumferential surface 102 of the tub gasket 100 to diffuse water supplied from the water supply module 200. FIGS. 5 and 8 show a water diffusion portion 140 according to an embodiment of the present disclosure.

The water diffusion portion 140 may protrude from the inner circumferential surface 102 of the tub gasket 100 toward the center of the tub gasket 100. On the inner circumferential surface 102 of the tub gasket 100, water discharged from the water supply module 200 may flow in the inner circumferential direction D1 of the tub gasket 100, and thus the water discharged from the water supply module 200 may flow with the flow area increased by the water diffusion portion 140.

The water diffusion portion 140 may have various shapes. For example, the water diffusion portion 140 may have the shape of a protrusion, such as a cylinder, a polygonal column, or a cone.

In addition, the water diffusion portion may have the shape of a rib extending in one direction, as shown in FIGS. 4 and 8. That is, in the embodiment of the present disclosure, the water diffusion portion 140 may extend across the inner circumferential direction D1.

The water diffusion portion 140 may extend from the outwardly facing end 103 to the inwardly facing end 104 of the inner circumferential surface 102 of the tub gasket 100. A plurality of water diffusion portions 140 may be provided and disposed in the inner circumferential direction D1 of the tub gasket 100.

In the embodiment of the present disclosure, water provided from the water supply module 200 may be discharged from the water discharge port 250 in an approximately point-like manner and may flow on the inner circumferential surface 102 of the tub gasket 100, and the water diffusion portion 140 may diffuse the water flowing on the inner circumferential surface 102 of the tub gasket 100 toward the outwardly facing end 103 and the inwardly facing end 104 of the inner circumferential surface 102 of the tub gasket 100.

Water flowing through the water diffusion portion 140 of the tub gasket 100 may have both a flow direction in which the water is diffused in the extension direction of the water diffusion portion 140 and a flow direction which the water passes beyond the water diffusion portion 140, thereby effectively increasing the cleaning area and cooling area of water that cleans the inner circumferential surface 102 of the tub gasket 100.

In FIG. 8, a flow direction in which water provided from the water supply module 200 to the inner circumferential surface 102 of the tub gasket 100 flows beyond the water diffusion portion 140 and a flow direction in which the water flows in the extension direction of the water diffusion portion 140 are shown by arrows.

Meanwhile, in the embodiment of the present disclosure, the water diffusion portion 140 is provided in plural, the plurality of water diffusion portions is spaced apart from each other in the inner circumferential direction of the tub gasket 100, and the plurality of water diffusion portions 140 includes a first water diffusion portion and a second water diffusion portion, wherein the second water diffusion portion may be located farther from the water supply module 200 than the first water diffusion portion and may extend longer than the first water diffusion portion. The plurality of water diffusion portions 140 may be configured to have a larger extension length with increasing distance from the water supply module 200.

FIG. 4 shows a plurality of water diffusion portions 140 configured to have a larger extension length with increasing distance from the water supply module 200. In the embodiment of the present disclosure, the first water diffusion portion and the second water diffusion portion may be arbitrarily selected among the plurality of water diffusion portions 140 based on the distance from the water supply module 200.

That is, one of the plurality of water diffusion portions 140 that is closer to the water supply module 200 may be the first water diffusion portion, and the other farther from the water supply module 200 than the first water diffusion portion may be the second water diffusion portion.

As described above, in the embodiment of the present disclosure, water discharged from the water supply module 200 located at the upper end of the tub gasket 100 is diffused by the water diffusion portion 140, and the water discharged from the water supply module 200 may flow beyond the water diffusion portion 140 or may flow in the extension direction of the water diffusion portion 140.

In the embodiment of the present disclosure, the extension length of the first water diffusion portion located closer to the water supply module 200 may be less than the extension length of the second water diffusion portion located farther from the water supply module 200 than the first water diffusion portion, thereby increasing the amount of water delivered to the second water diffusion portion via the first water diffusion portion and effectively increasing the area of the tub gasket 100 to which water is delivered.

Furthermore, in the embodiment of the present disclosure, the plurality of water diffusion portions 140 may be configured to have a larger extension length with increasing distance from the water supply module 200, thereby gradually increasing the amount of water delivered to the next water diffusion portion 140 via any one of the water diffusion portions 140.

Meanwhile, the water diffusion portions 140 may have a larger extension length with decreasing distance from a lower end of the tub gasket 100, which may increase the effect of guiding water such that the water flows to the leakage prevention recess 150 or the water discharge portion 130 of the tub gasket 100.

Meanwhile, as shown in FIG. 4, in the embodiment of the present disclosure, the plurality of water diffusion portions 140 may be configured to have a decreased distance therebetween with increasing distance from the water supply guide 240.

That is, the distance between a pair of neighboring ones of the plurality of water diffusion portions 140 may gradually decrease with increasing distance from the water supply guide 240.

Consequently, increasing the distance from the water supply guide 240 may increase fluidity of the water diffusion portions 140 in a longitudinal direction while allowing water from the region adjacent to the water discharge portion 130 to flow toward the leakage prevention recess 150 or the water discharge portion 130, resulting in stable discharge of water.

Meanwhile, in the embodiment of the present disclosure, the water diffusion portion 140 includes an inner end 142 facing the inside of the tub 20 and an outer end 141 located opposite the inner end 142, and the water diffusion portion 140 may extend such that the inner end 142 is located farther from the water supply module 200 than the outer end 141.

For example, when the water supply module 200 is located at the upper part of the tub gasket 100, the water diffusion portion 140 may extend such that the inner end 142 is located lower than the outer end 141.

FIG. 8 shows the water diffusion portion 140 downwardly inclined such that the inner end 142 is located farther from the water supply module 200 than the outer end 141 in accordance with the embodiment of the present disclosure.

As described above, the water supply guide 240 of the water supply module 200 may be disposed in contact with the leakage prevention protrusion 120 for effective cleaning of the main parts to be cleaned, and the inner end 142 of the water diffusion portion 140 facing the opposite side of the leakage prevention protrusion 120 may be located far from the water supply module 200 such that water is diffused naturally while flowing along the inner circumferential surface 102 of the tub gasket 100, taking into account the position of the water supply guide 240 and the flow direction of water.

The outer end 141 of the water diffusion portion 140 may be connected to or located adjacent to the leakage prevention protrusion 120, and the inner end 142 of the water diffusion portion 140 may be provided so as to face the leakage prevention recess 150.

Meanwhile, in the embodiment of the present disclosure, the height of the water diffusion portion 140 protruding from the inner circumferential surface 102 of the tub gasket 100 may be lower than the protruding height of the leakage prevention protrusion 120. In FIGS. 9 and 10, the water diffusion portion 140 having a lower height than the leakage prevention protrusion 120 is shown.

As described above, water passing through the water diffusion portion 140 may have a flow direction in which the water flows beyond the water diffusion portion 140 in the height direction, and the embodiment of the present disclosure may be designed such that the protruding height of the water diffusion portion 140 is lower than the protruding height of the leakage prevention protrusion 120 in order to prevent the water flowing beyond the water diffusion portion 140 in the height direction from leaking to the outside of the tub gasket 100 beyond the leakage prevention protrusion 120.

Meanwhile, FIG. 10 shows area B of the tub gasket 100 shown in FIG. 4 when viewed from the inside of the tub gasket 100. A lower part of the inner circumferential surface 102 of the tub gasket 100 may be provided with a water discharge portion 130 through which water present on the inner circumferential surface 102 of the tub gasket 100 or in the leakage prevention recess 150 is discharged to the outside of the tub gasket 100.

The water discharge portion 130 may be provided at the lower end of the tub gasket 100, and may communicate with the leakage prevention recess 150 such that water collected in the leakage prevention recess 150 can be discharged to the outside of the tub gasket 100.

The water discharge portion 130 may be provided with a plurality of through-holes configured to discharge water, and water discharged to the outside of the tub gasket 100 through the plurality of through-holes may flow along the water discharge channel 132 toward the drainage pump 60.

At least a part of the water discharge portion 130 may be located at a lower end of the inner circumferential surface 102 of the tub gasket 100. The through-holes of the water discharge portion 130, through which water is discharged, may be located in the leakage prevention recess 150 such that water collected in the leakage prevention recess 150, such as cleaning water or coolant discharged from the water supply module 200 and condensate generated by condensation of moisture in the air, can be easily discharged.

In addition, a part of the through-hole or some of the plurality of through-holes may be formed in the inner circumferential surface 102 of the tub gasket 100 such that water present on the inner circumferential surface 102 of the tub gasket 100 can also be easily discharged.

The through-hole of the water discharge portion 130 may be formed through the tub gasket 100 from the inner circumferential surface 102 to the outer circumferential surface, and may communicate with the water discharge channel 132. The water discharge channel 132 may extend from the tub gasket 100 to flow water discharged from the tub gasket 100 to the drainage pump 60.

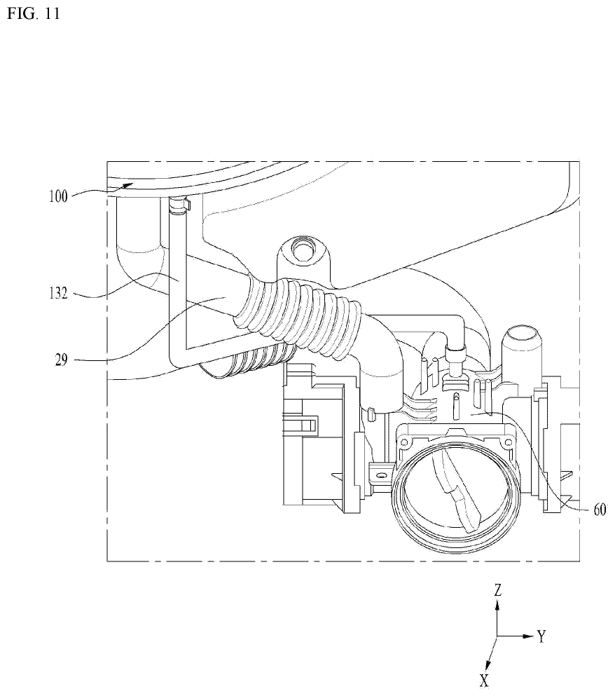

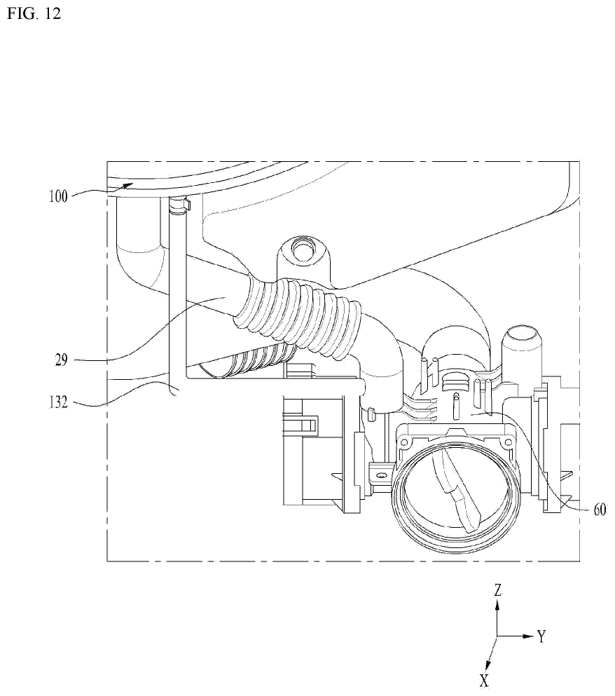

Meanwhile, each of FIGS. 11 and 12 shows the water discharge channel 132 through which water discharged from the tub gasket 100 flows in accordance with the embodiment of the present disclosure.

Specifically, FIG. 11 shows the water discharge channel 132 extending from the tub gasket 100 and connected to the drainage pump 60, and FIG. 12 shows the water discharge channel 132 extending from the tub gasket 100 and connected to the tub drainage channel 29 of the tub 20.

Water discharged from the tub gasket 100 may be discharged to the outside of the cabinet 10 using the drainage pump 60, in the same manner as water discharged from the tub 20. The water discharge channel 132 may directly connect the water discharge portion 130 of the tub gasket 100 to the drainage pump 60 to each other, or may connect the water discharge portion 130 and the tub drainage channel 29 to each other such that the drainage pump 60 can be indirectly connected.

In the embodiment of the present disclosure, water may be discharged from the water supply module 200 for cleaning and cooling of the tub gasket 100 during the drying cycle of laundry, and the drainage pump 60 may be operated to discharge condensate collected on the surface of the tub gasket 100.

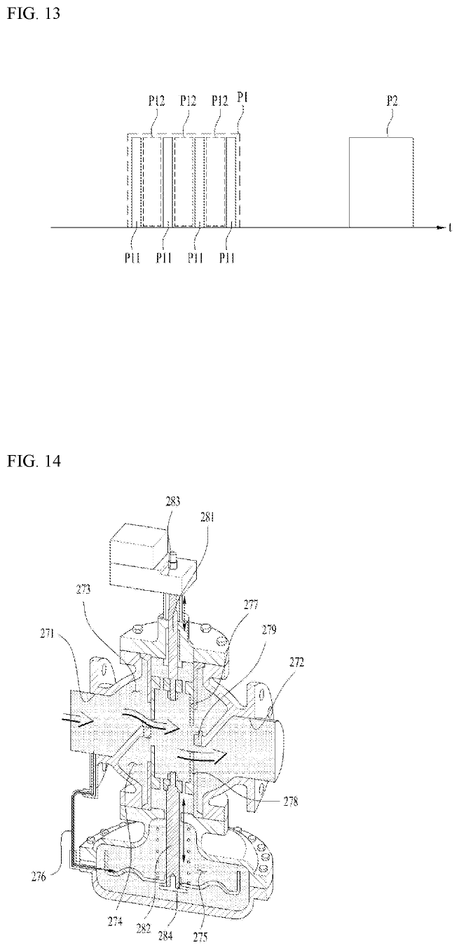

Meanwhile, FIG. 13 is an operational diagram conceptually showing the operational state of the water supply module 200 and the operational state of the drainage pump 60 in the embodiment of the present disclosure.

Referring to FIG. 13, in the embodiment of the present disclosure, a supply maintenance process P11, in which the discharge of water is performed, and a supply interruption process P12, in which the discharge of water is interrupted, may be alternately repeated in a discharge process P1, in which the water supply module 200 discharges water to the tub gasket 100.

That is, the water supply module 200 does not continuously discharge a preset quantity of water at once in the water discharge process P1 but may intermittently discharge water through a plurality of supply maintenance processes P11 that are separated in time by the supply interruption process P12.

Meanwhile, the progress time of the discharge process P1 in which the water supply module 200 is operated, the amount of water discharged, and the number of supply maintenance processes P11 may be preset in the controller 500. That is, the controller 500 may intermittently repeat the supply maintenance processes P11 by controlling opening and closing of the flow valve 270.

In addition, after the discharge process P1 of the water supply module 200, a drainage process P2, in which the drainage pump 60 is operated to drain water collected in the water discharge portion 130, may be performed. The controller 500 may control the drainage pump 60 to perform the drainage process P2 for a predetermined time.

That is, in the embodiment of the present disclosure, the discharge process P1 and the drainage process P2 may be performed by control of the flow valve 270 and the drainage pump 60 by the controller 500.

Specifically, the flow valve 270 may be provided in the cabinet 10 and may control the flow of water provided to the water supply module 200 according to an open or closed state thereof. In the open state of the flow valve 270, the flow of water in the gasket connection channel 260 is allowed to flow, whereby water may be discharged from the water supply module 200, and in the closed state of the flow valve 270, the flow of water in the gasket connection channel 260 is blocked, whereby the discharge of water from the water supply module 200 may be interrupted.

The controller 500 may be provided in the cabinet 10 to control the opening and closing states of the flow valve 270, and may control the opening and closing states of the flow valve 270 such that the supply maintenance process P11 and the supply interruption process P12 are repeated in the discharge process P1 of the water supply module 200.

Accordingly, the flow rate of water discharged from the water supply module 200 to cool the tub gasket 100 during the drying cycle may be adjusted to effectively inhibit the delivery of water into the drum 30.

Meanwhile, FIG. 14 shows the flow valve 270 provided on the gasket connection channel 260 connecting the water source connection unit 40 and the water supply module 200 to each other in accordance with the embodiment of the present disclosure.

Referring to FIG. 14, the flow valve 270 may correspond to a constant flow valve in which the flow rate of outgoing water remains constant regardless of flow pressure fluctuation in incoming water in an open state.

In the embodiment of the present disclosure, water may be supplied to various components, such as the tub 20 or the tub gasket 100, through the water source connection unit 40 connected to the external water source 50. Consequently, the flow pressure and flow rate of water supplied to the water supply module 200 may be changed if the object to which water is supplied from the water supply connection 40 is changed.

When water discharged from the water supply module 200 escapes the tub gasket 100 and is delivered outwardly or inwardly of the tub gasket 100, the water may be discharged to the outside of the cabinet 10 or may be re-supplied to the laundry in the tub 20 and drum 30 where the washing cycle is completed, which is disadvantageous.

In addition, if the flow pressure or flow rate of water discharged from the water supply module 200 deviates from an expected limit in design, there is an increased likelihood that the water discharged from the water supply module 200 will escape the tub gasket 100 and flow to the outside of the cabinet 10 or into the tub 20.

In order to prevent abnormal flow fluctuation of the water discharged from the water supply module 200 as described above, the flow valve 270 provided in the gasket connection channel 260 or the water supply connection unit 40 may correspond to a constant flow valve in the embodiment of the present disclosure.

The constant flow valve refers to a valve capable of maintaining constant flow pressure or flow rate of water discharged from the valve regardless of flow pressure fluctuation in water introduced into the valve.

FIG. 14 shows the internal structure of the flow valve 270 corresponding to the constant flow valve in accordance with the embodiment of the present disclosure. However, the internal structure of the flow valve 270 shown in FIG. 14 is only an example of the present disclosure, and is not necessarily limited to that structure.

Referring to FIG. 14 to describe the internal structure of the flow valve 270 corresponding to the constant flow valve, the flow valve 270 may include an inlet 271 through which water is introduced and an outlet 272 through which water is discharged, and may be provided therein with a first chamber 273, a second chamber 274, and a third chamber 275, in each of which water flows.

The first chamber 273 may communicate with the inlet 271, the second chamber 274 may communicate with the outlet 272, and the third chamber 275 may communicate with the inlet 271 via a synchronization channel 276.

Water may be introduced into the first chamber 273 through the inlet 271 to form first flow pressure. The synchronization channel 276 may be connected to the inlet 271 to allow the channel and the third chamber 275 to communicate with each other, whereby the first flow pressure may be formed in the third chamber 275 in the same manner as in the first chamber 273.

The flow valve 270 may be provided therein with a first opening and closing portion 277, a second opening and closing portion 278, and a closing ring 279. The closing ring 279 is fixed to a connection hole configured to connect the first chamber 273 and the second chamber 274 to each other, the first opening and closing portion 277 may be moved so as to come into contact with or become away from the closing ring 279 in the first chamber 273, and the second opening and closing portion 278 may be moved so as to come into contact with or become away from the closing ring 279 in the second chamber 274.

When the first opening and closing portion 277 comes into contact with the closing ring 279, connection between the first chamber 273 and the connection hole is blocked, and when the first opening and closing portion 277 is moved away from the closing ring 279, connection between the first chamber 273 and the connection hole is achieved. When the second opening and closing portion 278 comes into contact with the closing ring 279, connection between the second chamber 274 and the connection hole is blocked, and when the second opening and closing portion 278 is move away from the closing ring 279, connection between the second chamber 274 and the connection hole is achieved.

That is, water introduced into the first chamber 273 may flow to the outlet 272 via the second chamber 274 only when both the first opening and closing portion 277 and the second closure portion 278 are open.

The first opening and closing portion 277 may be connected to a first opening and closing rod 281, and may be provided with an opening and closing operation portion 283 including a motor, configured to move the first opening and closing portion 277 by moving the first opening and closing rod 281. The second opening and closing portion 278 is connected to a second opening and closing rod 282, and a pressure setting portion 284 including a spring and/or a diaphragm provides opening force equivalent to set pressure to the second opening and closing portion 278 via the second opening and closing rod 282.

That is, the second opening and closing portion 278 may be provided with opening force to move away from the closing ring 279 by pressure that is set by design by the pressure setting portion 284.

Meanwhile, the third chamber 275 may be configured to share the pressure setting portion 284 with the second chamber 274. That is, the third chamber 275, in which the first pressure is formed as in the first chamber 273, may provide closing force to the second opening and closing portion 278 via the pressure setting portion 284.

The flow valve 270 is operated as follows. First, the controller 500 may control the opening and closing operation portion 283 to open the first opening and closing portion 277. In this case, water introduced through the inlet 271 may be introduced into the first chamber 273 with the first opening and closing portion 277 open but the second opening and closing portion 278 closed. The water introduced into the first chamber 273 may provide opening force equivalent to the first pressure to the second opening and closing portion 278.

Meanwhile, the first pressure formed in the third chamber 275 through the pressure setting portion 284 and the second opening and closing rod 282 may be provided to the second opening and closing portion 278 as closing force, and the pressure set by the pressure setting portion 284 may be provided as opening force.

As a result, in the state in which the first opening and closing portion 277 is open, only the set pressure corresponding to the opening force may act on the second opening and closing portion 278, and the second opening and closing portion 278 may be moved away from the closing ring 279 and opened in response to the set pressure.

In this process, the opening force acting on the second opening and closing portion 278 may always be maintained at the set pressure regardless of flow pressure of water introduced through the inlet 271, and therefore the flow rate or flow pressure of water discharged to the outlet 272 through opening of the second opening and closing portion 278 may be maintained at a level set by the pressure setting portion 284.

In the embodiment of the present disclosure, the flow valve 270, which corresponds to a constant flow valve, may be used, whereby the flow rate and flow pressure of water may be maintained uniform even when water is supplied to the water supply module 200 from the water source connection unit 40, which is connected to a plurality of channels and in which flow pressure may be changed, and therefore it is possible to prevent unintentional leakage of water outside the tub gasket 100.

Meanwhile, an embodiment of the present disclosure may include a cabinet, a tub, a drum, a tub gasket, a water supply module 200, a flow valve, and a controller configured to control the flow valve such that water is supplied to the tub gasket to cool the tub gasket during a drying cycle for drying laundry, as described above. In addition, an embodiment of the present disclosure may include a cabinet, a tub, a drum, a tub gasket, and a water supply module 200 provided in the cabinet, the water supply module being configured to supply water to an inner circumferential surface of the tub gasket to clean the inner circumferential surface before or during a drying cycle for drying laundry.

While the present disclosure has been shown and described with reference to specific embodiments, it will be apparent to those ordinary skilled in the art that various improvements and changes may be made to the present disclosure without departing from the technical ideas of the present disclosure as provided by the following claims.

What is claimed is:

1. A laundry treating apparatus comprising:
a cabinet comprising a front plate having a laundry opening formed therein;
a tub provided in the cabinet, the tub comprising a tub opening facing the laundry opening;
a drum rotatably provided in the tub, the drum being configured to receive laundry;
a tub gasket provided between the front plate and the tub, the tub gasket extending along a circumference of the laundry opening;
a gasket water supply portion provided at the tub gasket, the gasket water supply portion being configured to receive water from an outside of the tub gasket during a drying cycle for drying laundry; and
a water supply guide provided at an inner circumferential surface of the tub gasket, the water supply guide being in communication with the gasket water supply portion, the water supply guide being configured to discharge water supplied from the gasket water supply portion along the inner circumferential surface of the tub gasket during the drying cycle.

2. The laundry treating apparatus of claim 1, wherein the gasket water supply portion extends through the inner circumferential surface of the tub gasket toward the outside of the tub gasket to receive water.

3. The laundry treating apparatus of claim 2, wherein the tub gasket comprises a protruding support portion protruding toward the outside of the tub gasket, the protruding support portion being configured to allow the gasket water supply portion to extend therethrough, the protruding support portion surrounding at least a part of the gasket water supply portion.

4. The laundry treating apparatus of claim 1, wherein at least a part of the water supply guide is located at an upper end of the inner circumferential surface of the tub gasket, and the water supply guide comprises a water discharge port configured to discharge water toward the inner circumferential surface of the tub gasket.

5. The laundry treating apparatus of claim 4, wherein a discharging direction of water through the water discharge port of the water supply guide is parallel to an inner circumferential direction of the tub gasket.

6. The laundry treating apparatus of claim 5, wherein the water supply guide is connected to the gasket water supply portion, and at least a part of the water supply guide extends in the inner circumferential direction of the tub gasket.

7. The laundry treating apparatus of claim 6, wherein the water discharge port is formed at each end of the water supply guide in an extension direction of the water supply guide.

8. The laundry treating apparatus of claim 6, wherein an outer circumferential surface of the water supply guide facing the inner circumferential surface of the tub gasket is in contact with the inner circumferential surface of the tub gasket.

9. The laundry treating apparatus of claim 6, wherein
the tub gasket comprises a leakage prevention protrusion protruding from an outwardly facing end of the inner circumferential surface of the tub gasket facing an outside of the cabinet, the leakage prevention protrusion extending in the inner circumferential direction, and the water supply guide is in contact with the leakage prevention protrusion.

10. The laundry treating apparatus of claim 9, wherein
the gasket water supply portion comprises a water supply channel configured to allow water introduced from the outside of the tub gasket to flow therethrough,
the water supply guide comprises a guide channel configured to connect the water supply channel and the water discharge port to each other, and
at least a part of the guide channel is located between the leakage prevention protrusion and the water supply channel.

11. The laundry treating apparatus of claim 1, wherein the tub gasket comprises a leakage prevention recess provided at an inwardly facing end of the inner circumferential surface of the tub gasket facing the tub, the leakage prevention recess being depressed away from a center of the tub gasket, the leakage prevention recess being configured to collect water.

12. The laundry treating apparatus of claim 11, wherein the tub gasket further comprises a water discharge portion provided at a lower end of the tub gasket, the water discharge portion being in communication with the leakage prevention recess, the water discharge portion being configured to discharge the water collected in the leakage prevention recess to the outside of the tub gasket.

13. The laundry treating apparatus of claim 1, wherein the tub gasket comprises a water diffusion portion protruding from the inner circumferential surface of the tub gasket, the water diffusion portion being configured to guide a flow of water on the inner circumferential surface of the tub gasket.

14. The laundry treating apparatus of claim 13, wherein the water diffusion portion extends across the inner circumferential direction.

15. The laundry treating apparatus of claim 14, wherein
the water diffusion portion is provided in plural, and
the plurality of water diffusion portions is configured to have a larger extension length with increasing distance from the water supply guide.

16. The laundry treating apparatus of claim 14, wherein
the water diffusion portion is provided in plural, and
a distance between neighboring ones of the plurality of water diffusion portions gradually decreases with increasing distance from the water supply guide.

17. The laundry treating apparatus of claim 14, wherein
the water diffusion portion comprises an inner end facing an inside of the tub and an outer end located opposite the inner end, and
the water diffusion portion extends such that the inner end is located farther from the gasket water supply portion than the outer end.

18. The laundry treating apparatus of claim 14, wherein the tub gasket comprises a leakage prevention protrusion protruding from an outwardly facing end of the inner circumferential surface of the tub gasket facing an outside of the cabinet toward a center of the laundry opening, the leakage prevention protrusion extending in the inner circumferential direction.

19. The laundry treating apparatus of claim 1, wherein the gasket water supply portion alternately performs a supply maintenance process in which water is supplied to the water supply guide and a supply interruption process in which a supply of water to the water supply guide is interrupted during the drying cycle.

20. The laundry treating apparatus of claim 19, further comprising:
a flow valve provided in the cabinet, the flow valve being configured to control a flow of water provided to the gasket water supply portion; and
a controller provided in the cabinet, the controller being configured to control the flow valve such that the supply maintenance process and the supply interruption process of the gasket water supply portion are repeated during the drying cycle.

21. The laundry treating apparatus of claim 1, further comprising:
a flow valve provided in the cabinet, the flow valve being configured to control a flow of water provided to the gasket water supply portion, wherein
the flow valve is a constant flow valve configured to maintain a constant flow pressure of water discharged from the flow valve.

22. The laundry treating apparatus of claim 1, further comprising:
a heating unit provided in the cabinet, the heating unit being configured to heat air in the tub during the drying cycle, wherein
the tub is heated by the heating unit in a stagnant state of air therein during the drying cycle and is dehumidified by contact with the tub gasket.

23. The laundry treating apparatus of claim 22, wherein
the heating unit provides an electromagnetic field from an outside of the tub to an inside of the tub, and
the drum is heated by induced current formed by the electromagnetic field, whereby air in the tub is heated.

24. A laundry treating apparatus comprising:
a cabinet comprising a front plate having a laundry opening formed therein;
a tub provided in the cabinet, the tub comprising a tub opening facing the laundry opening;
a drum rotatably provided in the tub, the drum being configured to receive laundry;
a tub gasket provided between the laundry opening and the tub opening, the tub gasket extending along a circumference of the laundry opening, the tub gasket being configured to seal between the laundry opening and the tub opening;
a gasket water supply portion provided at the tub gasket, the gasket water supply portion being configured to receive water from an outside of the tub gasket;
a water supply guide provided at the tub gasket, the water supply guide being configured to flow water delivered from the gasket water supply portion along an inner circumferential surface of the tub gasket;
a flow valve configured to control a flow of water delivered to the gasket water supply portion; and
a controller configured to control the flow valve such that water is supplied to the tub gasket during a drying cycle for drying laundry.
